(19) United States
(12) Patent Application Publication
(10) Pub. No.: US 2008/0267042 A1
(43) Pub. Date: Oct. 30, 2008

(54) OPTICAL PICKUP DEVICE

(75) Inventors: Yasuyuki KANO, Anpachi-gun (JP); Satomi Osugi, Kaidu-Shi (JP); Tetsuhisa Hosokawa, Anpachi-Gun (JP)

Correspondence Address: DITTHAVONG MORI & STEINER, P.C., 918 Prince St., Alexandria, VA, 22314, US

(73) Assignees: Sanyo Electric Co., Ltd., Moriguchi-shi (JP); SANYO Optec Design Co., Ltd., Tokyo (JP)

(21) Appl. No.: 12/108,908

(22) Filed: Apr. 24, 2008

(30) Foreign Application Priority Data
Apr. 24, 2007 (JP) 2007-114038
Oct. 30, 2007 (JP) 2007-281534

(51) Int. Cl. G11B 7/135

(52) U.S. Cl. 369/112.16

(57) ABSTRACT

A quarter-wave plate and a polarization beam splitter are used as means for guiding a laser beam to first and second objective lenses. A half of the circularly-polarized laser beam incident to the polarization beam splitter is reflected in the form of an S-polarized light component by the polarization beam splitter and guided to a first objective lens, and the other half is transmitted through the polarization beam splitter in the form of a P-polarized light component and guided to a second objective lens. The whole of light quantity of the laser beam reflected from an optical disk through the first or second objective lens passes substantially through the polarization beam splitter. Therefore, the light quantity of the laser beam guided to a photodetector can be enhanced.

This application claims priority under 35 U.S.C. Section 119 of Japanese Patent Application No. 2007-114038 filed Apr. 24, 2007, entitled “OPTICAL PICKUP DEVICE”, and Japanese Patent Application No. 2007-281534 filed Oct. 30, 2007, entitled “OPTICAL PICKUP DEVICE”.

### BACKGROUND OF THE INVENTION

1. Field of the Invention

The present invention relates to an optical pickup device, particularly to an optical pickup device which is suitably used to irradiate different kinds of optical disks with a laser beam through plural objective lenses.

2. Description of the Related Art

With diversification of the optical disk, a compatible type optical pickup device which can irradiate the different kinds of optical disks with a laser beam has been developed. In this kind of optical pickup device, two objective lenses compatible with Blu-ray Disc (hereinafter referred to as “BD”) and HD DVD (High-Definition Digital Versatile Disc, hereinafter referred to as “HD”) are mounted on an optical pickup device compatible with BD and HD, because BD and HD differ from each other in a cover thickness of the optical disk and NA (numerical aperture) of the objective lens. Because BD and HD are identical to each other in a wavelength band of a laser beam used in the optical pickup device compatible with BD and HD, desirably one semiconductor laser is used as a light source shared by BD and HD and the laser beam from the semiconductor laser is sorted into the objective lenses.

A liquid crystal cell and a polarization beam splitter can be used to sort the laser beam emitted from the one semiconductor laser into the two objective lenses. That is, the liquid crystal cell changes a polarization direction of the laser beam to one of the P-polarized light and S-polarized light with respect to the polarization beam splitter. In the case of the P-polarized light, the laser beam is transmitted through the polarization beam splitter and guided to the first objective lens. In the case of the S-polarized light, the laser beam is reflected by the polarization beam splitter and guided to the first objective lens. Alternatively, a half-wave plate is disposed in front of the polarization beam splitter, and the half-wave plate can be inserted into and retracted from the optical path to sort the laser beam into the two objective lenses.

However, in the configuration in which the liquid crystal cell is used, unfortunately the liquid crystal cell increases cost of the optical pickup device, and a need of means for driving the liquid crystal cell complicates configuration and control of the optical pickup device. Similarly, in the configuration in which the half-wave plate is inserted and retracted, a need of means for driving the half-wave plate arises to complicate the configuration and control of the optical pickup device.

When the compatible optical pickup device is used for recording, desirably the laser beam from the semiconductor laser is guided only to the corresponding objective lens in order to ensure laser beam intensity during the irradiation of the optical disk. On the other hand, when the compatible optical pickup device is used for reproduction, the laser beam can simultaneously be guided to both the objective lenses, because the laser beam has the laser beam intensity enough to be able to perform the reproduction during the irradiation of the optical disk. However, even in such cases, it is necessary that a light quantity ratio of the laser beam with which the optical disk is irradiated and the laser beam guided to the photodetector be maintained at a predetermined value or more in order to ensure S/N in a reproduction signal, a focus error signal, and a tracking error signal.

FIG. 11 shows an example of a configuration of an optical pickup device on which the one objective lens is mounted. A diffraction grating 52 divides the laser beam emitted from the semiconductor laser 51 into three beams, and a non-polarized mirror 53 divides the laser beam to reflect 90% of the laser beam onto the sides of a collimator lens 54. Then, the collimator lens 54 converts the laser beam into parallel light, a reflecting mirror 55 reflects the laser beam, and the laser beam is incident to an objective lens 56. Then, the laser beam is collected on the optical disk. The reflecting mirror 55 reflects the laser beam reflected by the optical disk, and the collimator lens 54 converts the laser beam into convergent light. Then, the non-polarized mirror 53 divides the laser beam to collect 9% of the laser beam of the light quantity in the time when the laser beam is emitted from the semiconductor laser 51 on a photodetector 57.

In the configuration of FIG. 11, the light quantity ratio of the laser beam with which the optical disk is irradiated and the laser beam guided to the photodetector 57 is 10:1 (however, transmittance/reflectance of each optical component and the optical disk is not included).

FIG. 12 shows an example of a configuration of an optical pickup device on which the two objective lenses are mounted. Referring to FIG. 12, a half-mirror prism 61 is used as means for dividing the laser beam into two objective lenses 62 and 64. The diffraction grating 52 divides the laser beam emitted from the semiconductor laser 51 into three beams, and the non-polarized mirror 53 divides the laser beam to reflect 90% of the laser beam onto the sides of the collimator lens 54. Then, the collimator lens 54 converts the laser beam into the parallel light, the half-mirror prism 61 reflects a half of the laser beam, and the laser beam is collected on the optical disk through the first objective lens 62. On the other hand, the laser beam transmitted through the half-mirror prism 61 is reflected by a reflecting mirror 63, and the laser beam is collected on the optical disk through the second objective lens 64. In this case, the light quantity of the laser beam with which the optical disk is irradiated through the first and second objective lenses 62 and 64 is 45% of the light quantity of the laser beam in the time when the laser beam is emit Led from the semiconductor laser 51.

The reflecting mirror 63 and the half-mirror prism 61 reflect the laser beam reflected by the optical disk. At this point, in the laser beam, the light quantity is decreased to half by the half-mirror prism 61. Then, the collimator lens 54 converts the laser beam into the convergent light, and the non-polarized mirror 53 divides the laser beam. As a result, the laser beam having 2.25% of the light quantity in the time when the laser beam is emitted from the semiconductor laser 51 is collected on the photodetector 57.

In the configuration of FIG. 12, the light quantity ratio of the laser beam with which the optical disk is irradiated and the laser beam guided to the photodetector 57 is 20:1 (however, transmittance/reflectance of each optical component and the optical disk is not included).

Thus, when the half-mirror prism 61 is used as the means for dividing the laser beam into the two beams incident to the objective lenses, because the light quantity of the laser beam is decreased by 50% in the approach and return routes respectively, the light quantity ratio of the laser beam with which the optical disk is irradiated and the laser beam guided to the photodetector 57 is decreased to half or less (20:1) the optical pickup device with the one objective lens. Therefore, S/N of the signal outputted from the photodetector 57 is not enough to perform the reproduction.

### SUMMARY OF THE INVENTION

In accordance with a first aspect of the invention, an optical pickup device includes a laser beam source which emits a laser beam having a predetermined wavelength; first and second objective lenses which cause the laser beam to converge; a polarization beam splitter which sorts the laser beam from the laser beam source into the first and second objective lenses; and a quarter-wave plate which is disposed between the laser beam source and the polarization beam splitter, the quarter-wave plate causing the laser beam to enter into the polarization beam splitter in a form of circularly polarized light.

In accordance with a second aspect of the invention, an optical pickup device includes a laser beam source which emits a laser beam having a predetermined wavelength; first and second objective lenses which cause the laser beam to converge on a recording medium; a polarization beam splitter which sorts the laser beam from the laser beam source into the first and second objective lenses; first and second quarter-wave plates which are disposed in optical paths between the polarization beam splitter and the first and second objective lenses respectively; a photodetector which accepts the laser beam, being reflected by recording medium and passing the polarization beam splitter; and a quarter-wave plate which is disposed between the laser beam source and the polarization beam splitter, the quarter-wave plat causing the laser beam to enter into the polarization beam splitter in a form of circularly polarized light.

According to the optical pickup devices of the first and second aspects, the polarization beam splitter and the inexpensive quarter-wave plate is used as the means for guiding the laser beam to the first and second objective lenses, so that cost of the optical pickup device can be reduced. It is not necessary to provide the configuration for driving the liquid crystal cell and the configuration for inserting and retracting the half-wave plate, so that complication of the configuration or control can be prevented. Additionally, according to the optical pickup devices of the first and second aspects, the whole of light quantity of the laser beam reflected from the optical disk through the first or second objective lens passes substantially through the polarization beam splitter, so that not only the light quantity of the laser beam guided to the photodetector can be enhanced, but also S/N of the signal outputted from the photodetector can be kept at a proper level.

In accordance with a third aspect of the invention, an optical pickup device includes a laser beam source which emits a laser beam having a predetermined wavelength; first and second objective lenses which cause the laser beam to converge; a polarization beam splitter which sorts the laser beam from the laser beam source into the first and second objective lenses; and a half-wave plate which is disposed between the laser beam source and the polarization beam splitter, the half-wave plate causing the laser beam to enter into the polarization beam splitter in a form of linearly polarized light inclined by a predetermined angle with respect to a polarizing axis of the polarization beam splitter.

According to the optical pickup device of the third aspect, the polarization beam splitter and the inexpensive half-wave plate is used as the means for guiding the laser beam to the first and second objective lenses, so that cost of the optical pickup device can be reduced. Similarly to the optical pickup devices of the first and second aspects, the complication of the configuration or control can be prevented, and S/N of the signal outputted from the photodetector can be enhanced.

In accordance with a fourth aspect of the invention, an optical pickup device includes a laser beam source which emits a laser beam having a predetermined wavelength; first and second objective lenses which cause the laser beam to converge; and a polarization beam splitter which sorts the laser beam from the laser beam source into the first and second objective lenses, wherein the laser beam source is disposed such that the laser beam emitted from the laser beam source is incident in a form of linearly polarized light inclined by a predetermined angle with respect to a polarizing axis of the polarization beam splitter.

According to the optical pickup device of the fourth aspect, the laser beam source is disposed such that the laser beam is incident in the form of the linearly polarized light inclined by the predetermined angle with respect to the polarizing axis of the polarization beam splitter, thereby guiding the laser beam to the first and second objective lenses. Therefore, it is not necessary to separately provide the quarter-wave plate or half-wave plate, so that cost of the optical pickup device can be reduced. Similarly to the optical pickup devices of the first and second aspects, the complication of the configuration or control can be prevented, and S/N of the signal outputted from the photodetector can be enhanced.

In accordance with a fifth aspect of the invention, an optical pickup device includes a laser beam source which emits a laser beam having a predetermined wavelength; first and second objective lenses which cause the laser beam to converge onto a recording medium; a polarization beam splitter which sorts the laser beam from the laser beam source into the first and second objective lenses; first and second quarter-wave plates which are disposed in optical paths between the polarization beam splitter and the first and second objective lenses respectively; and a photodetector which accepts the laser beam, being reflected by recording medium and passing the polarization beam splitter, wherein the laser beam emitted from the laser beam source is incident in a form of linearly polarized light inclined by a predetermined angle with respect to a polarizing axis of the polarization beam splitter.

According to the optical pickup device of the fifth aspect, the laser beam is incident to the polarization beam splitter in the form of the linearly polarized light inclined by the predetermined angle with respect to the polarizing axis of the polarization beam splitter, thereby guiding the laser beam to the first and second objective lenses. Therefore, the laser beam emitted from the laser beam source can smoothly be sorted into first and second objective lenses. Additionally, the whole of light quantity of the laser beam reflected from the optical disk through the first or second objective lens passes substantially through the polarization beam splitter, so that not only the light quantity of the laser beam guided to the photodetector can be enhanced, but also S/N of the signal outputted from the photodetector can be enhanced.

### BRIEF DESCRIPTION OF THE DRAWINGS

The above and further objects and novel features of the invention will more fully appear from the following description of embodiments with reference to the accompanying drawings, in which:

FIG. 1 shows a configuration of an optical pickup device according to a first embodiment of the invention;

FIGS. 2A and 2B show a state in which a photodetector of the first embodiment is irradiated with a laser beam;

FIG. 3 shows a state of a focus error signal of the first embodiment;

FIG. 4 shows an example of a configuration of a signal computation circuit of the first embodiment;

FIGS. 5A and 5B show a configuration of an optical pickup device according to a second embodiment of the invention;

FIG. 6 shows a configuration of an optical pickup device according to a third embodiment of the invention;

FIG. 7 shows a modification of the optical pickup device of the third embodiment;

FIGS. 8A and 8B show a configuration of an optical pickup device according to a fourth embodiment of the invention;

FIGS. 9A and 9B show a modification of the optical pickup device of the fourth embodiment;

FIGS. 10A and 10B show another modification of the optical pickup device of the fourth embodiment;

FIG. 11 is a view explaining a problem to be solved in the invention; and

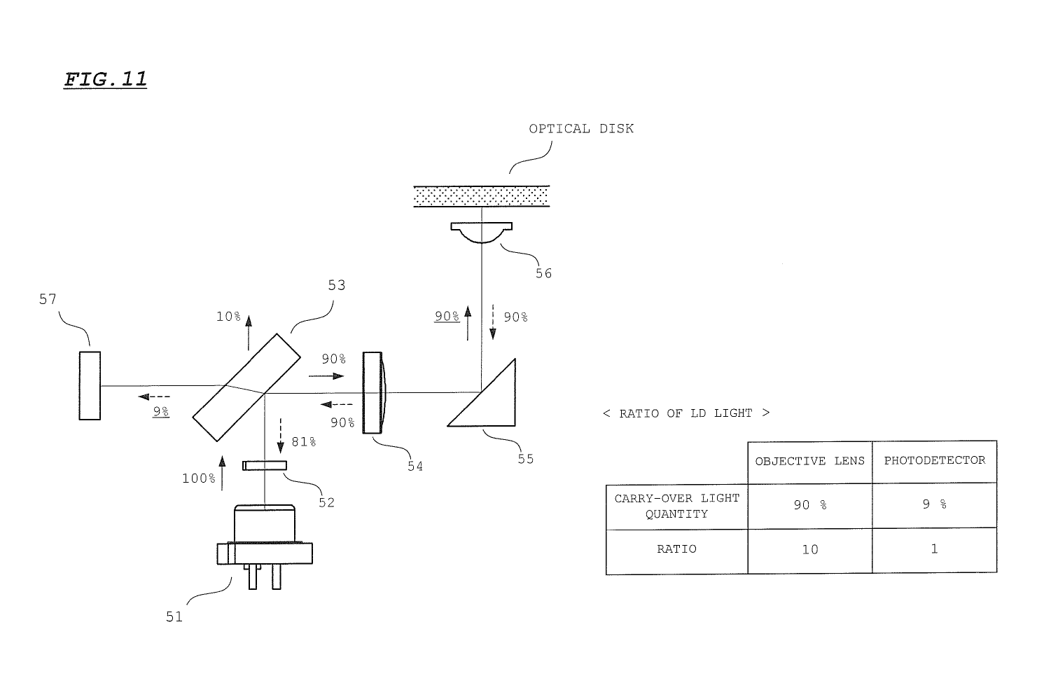

FIG. 12 is a view explaining a problem to be solved in the invention.

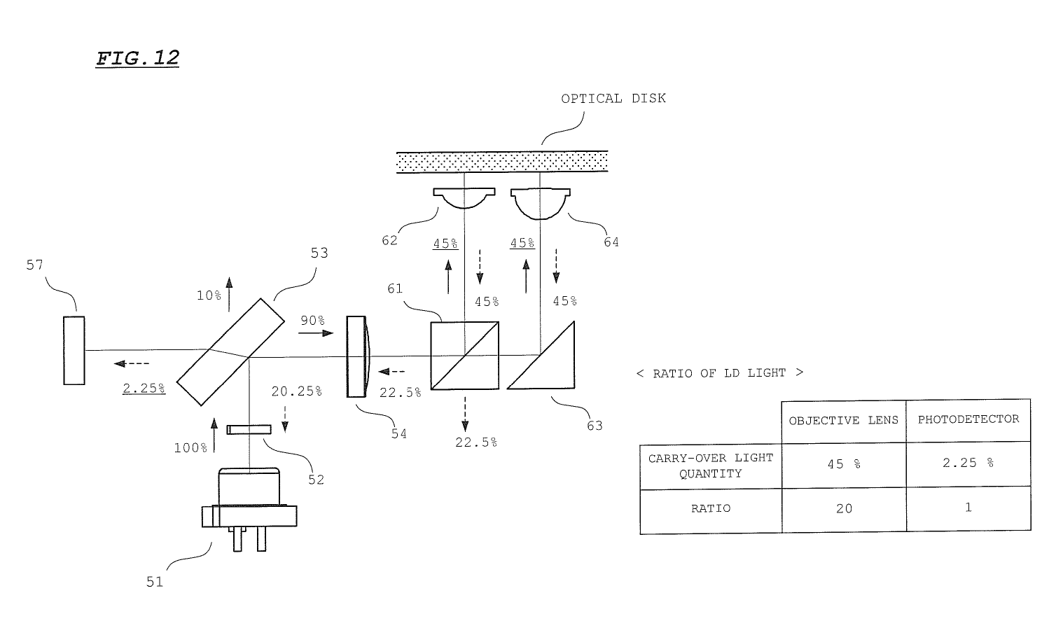

However, the drawings are illustrated only by way of example without limiting the scope of the invention.

### DESCRIPTION OF PREFERRED EMBODIMENTS

Preferred embodiments of the invention will be described below with reference to the drawings. In the following embodiments, the invention is applied to an optical pickup device compatible with BD and HD.

### First Embodiment

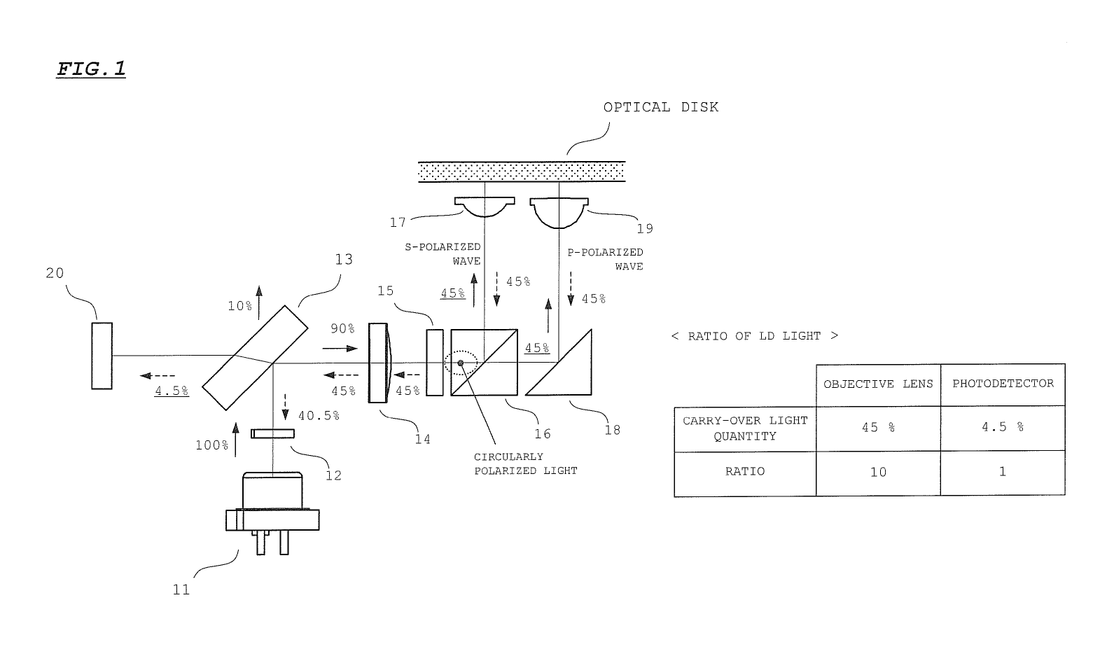

FIG. 1 shows a configuration (optical system) of an optical pickup device according to a first embodiment of the invention. Referring to FIG. 1, a semiconductor laser (laser beam source) 11 emits a blue laser beam having a wavelength of about 405 nm, a diffraction grating 12 divides the laser beam from the semiconductor laser 11 into three beams, and a parallel plate-like non-polarized mirror 13 reflects 90% of the incident laser beam and transmits 10% of the incident laser beam. The non-polarized mirror 13 is disposed so as to be inclined by a predetermined angle (for example, 45 degrees) with respect to an optical axis of the incident laser beam.

A collimator lens 14 converts the laser beam reflected by the non-polarized mirror 13 into the parallel light, and a quarter-wave plate 15 converts the laser beam transmitted through the collimator lens 14 into circularly polarized light.

A first objective lens 17 causes the laser beam reflected by a polarization beam splitter 16 to converge on HD, a reflecting mirror 18 reflects the laser beam (P-polarized light) transmitted through the polarization beam splitter 16, a second objective lens 19 causes the laser beam (P-polarized light) reflected by the reflecting mirror 18 to converge on BD, and a photodetector 20 accepts the laser beam reflected from HD or BD to generate various signals.

The first objective lens 17 and second objective lens 19 are designed so as to be able to cause the laser beam to converge properly on HD and BD. The first and second objective lenses 17 and 19 are integrally driven in focus and tracking directions by an objective lens actuator (not shown).

The diffraction grating 12 divides the laser beam emitted from the semiconductor laser 11 into three beams, and the non-polarized mirror 13 divides the laser beam to reflect 90% of the laser beam onto the collimator lens 14. Then, the collimator lens 14 converts the laser beam into the parallel light, and the quarter-wave plate 15 converts the laser beam into the circularly polarized light. Then, the laser beam is incident to the polarization beam splitter 16.

A half of the laser beam incident to the polarization beam splitter 16 is reflected in the form of an S-polarized light component by the polarization beam splitter 16, and the other half is transmitted through the polarization beam splitter 16 in the form of a P-polarized light component. The laser beam of the S-polarized light component (hereinafter referred to as “first laser beam”) is collected on the optical disk through the first objective lens 17, and the laser beam of the P-polarized light component (hereinafter referred to as “second laser beam”) is reflected by the reflecting mirror 18 and collected on the optical disk through the second objective lens 19. Accordingly, the light quantity of the laser beam with which the optical disk is irradiated through the first and second objective lens 17 or 19 becomes 45% of the light quantity of the laser beam in the time when the laser beam is emitted from the semiconductor laser 11.

The polarization beam splitter 16 reflects about 100% of the first laser beam reflected from the optical disk, because the first laser beam is incident to the polarization beam splitter 16 in the form of the S-polarized light. The polarization beam splitter 16 transmits about 100% of the second laser beam reflected from the optical disk, because the second laser beam is incident to the polarization beam splitter 16 in the form of the P-polarized light.

Then, the collimator lens 14 converts the first and second laser beams into the convergent light and the non-polarized mirror 13 divides the first and second laser beams. As a result, the light quantity of the first and second laser beams guided to the photodetector 20 becomes 4.5% of the light quantity in the time when the laser beam is emitted from the semiconductor laser 11.

Because the first and second laser beams are incident to the non-polarized mirror 13 in the form of the convergent light, the non-polarized mirror 13 induces astigmatism to the first and second laser beams. In the first embodiment, the astigmatism generates a focus error signal. A quadratic sensor is provided in the photodetector 20 based on an astigmatism method.

In the first embodiment, the light quantity ratio of the laser beam with which the optical disk is irradiated and the laser beam guided to the photodetector 20 becomes 10:1 (however, transmittance/reflectance of each optical component and the optical disk is not included). Therefore, S/N of the signal outputted from the photodetector 20 is enough to be able to perform the reproduction.

In the first embodiment, the optical disk is simultaneously irradiated with the laser beams passing through the first and second objective lenses 17 and 19. However, due to a difference in cover thickness between HD and BD, the second laser beam does not converge properly on HD when HD is reproduced by using the first laser beam, and the second laser beam does not converge properly on BD when BD is reproduced by using the second laser beam. Therefore, there is no trouble in the reproduction signal even if the first and second laser beams are accepted with a common sensor pattern (photodetector 20).

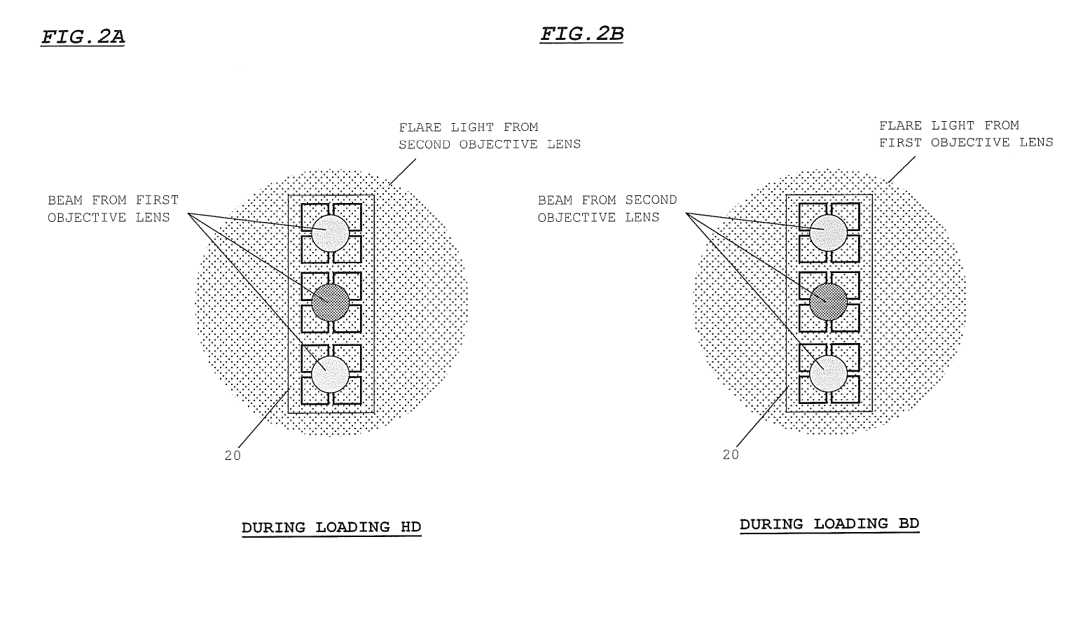

As shown in FIG. 2A, the second laser beam (flare light) reflected by HD does not converge on the photodetector 20 when the HD is reproduced by using the first laser beam. As shown in FIG. 2B, the first laser beam (flare light) reflected by BD does not converge on the photodetector 20 when the BD is reproduced by using the second laser beam. In this case, although the flare light superimposes the DC component with the signal outputted from the photodetector 20, the DC component is appropriately canceled on a reproduction circuit side.

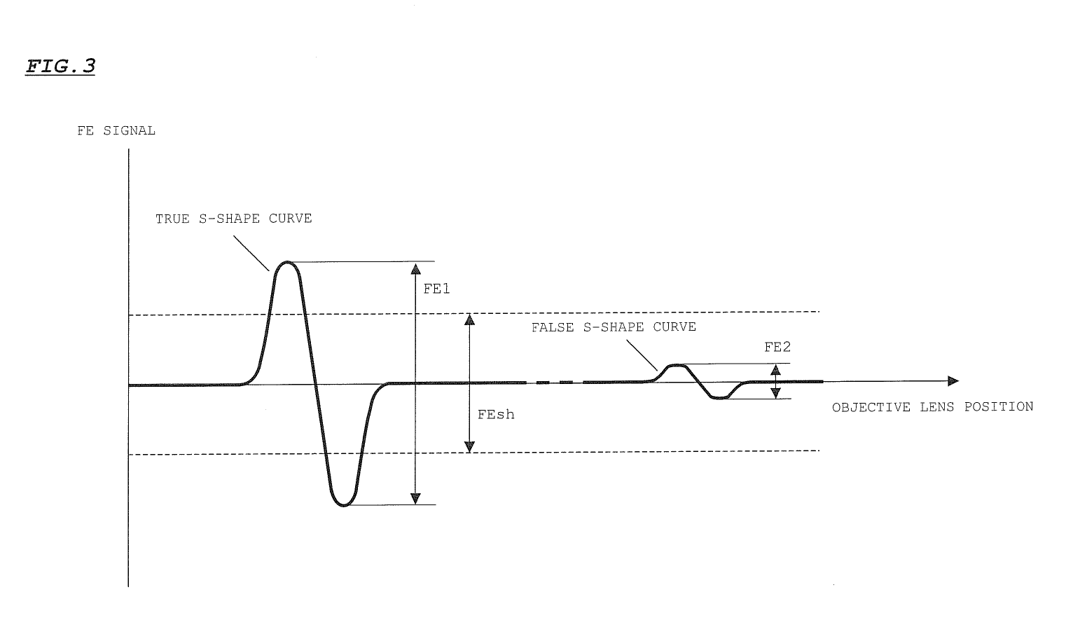

As schematically shown in FIG. 3, during focus pull-in to the target disk, because an S-shape curve is not properly generated depending on the laser beam which is not used for the reproduction in the first and second laser beams, there is no possibility of performing the focus pull-in based on the S-shape curve. In FIG. 3, a threshold level FEsh is set in order to identify the S-shape curve of the focus pull-in. The letter FE1 designates an amplitude of the S-shape curve (true S-shape curve) generated based on the laser beam used for the reproduction in the first and second laser beams, and the letter FE2 designates an amplitude of the S-shape curve (false S-shape curve) generated based on the laser beam which is not used for the reproduction in the first and second laser beams.

In the first embodiment, because BD and HD differ from each other in a track pitch, an in-line type diffraction pattern is applied to a diffraction pattern of the diffraction grating 12. Therefore, the laser beam reflected from the optical disk can be accepted by a common light acceptance plane irrespective of BD or HD of the reproduction target disk. Because the in-line type DPP method is well known, the description is omitted.

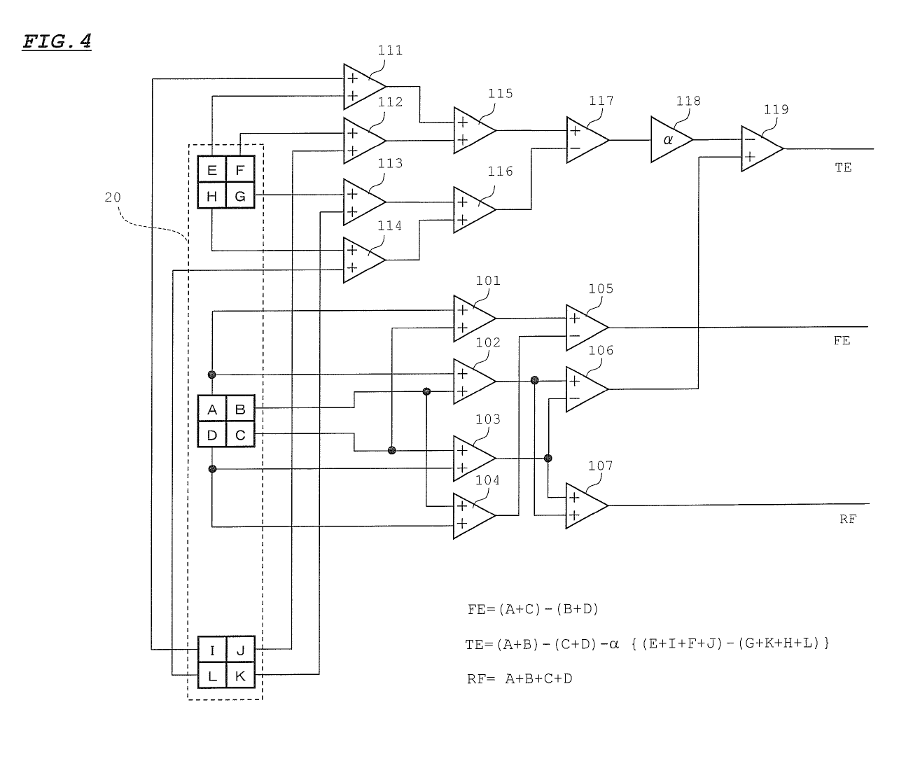

FIG. 4 shows a configuration of a signal computation circuit when the DPP method is adopted. As shown in FIG. 4, the signal computation circuit includes adding circuits 101 to 104, subtracting circuits 105 to 107, adding circuits 111 to 116, subtracting circuits 117 and 119, and a multiplying circuit 118. The photodetector 20 includes a main light beam accepting quadratic sensors A to D and sub-light beam accepting quadratic sensors E to G and I to L.

Assuming that A to L are signals outputted from the quadratic sensors A to L, a tracking error signal (TE) is generated by the following computation:

TE=(A+B)−(C+D)−α{(E+I+F+J)−(G+K+H+L)}

A focus error signal (FE) and a reproduction signal (RF) are generated by the following computation:

FE=(A+C)−(B+D) and RF=A+B+C+D

The tracking error signal may be generated by a one-beam push pull method. In such cases, the quadratic sensors E to L are omitted, and the signal computation circuit is also changed according to the one-beam push pull method.

Thus, in the first embodiment, the polarization beam splitter 16 and the inexpensive quarter-wave plate 21 are used as the means for guiding the laser beam to the first and second objective lenses 17 and 19, so that the cost of the optical pickup device can be reduced. It is not necessary to provide the configuration for driving the liquid crystal cell and the configuration for inserting and retracting the half-wave plate, so that the complication of the configuration or control can be prevented.

Additionally, in the first embodiment, the whole of light quantity of the laser beam reflected from the optical disk passes substantially through the polarization beam splitter 16, so that the light quantity of the laser beam guided to the photodetector 20 can be enhanced and the light quantity ratio of the laser beam with which the optical disk is irradiated and the first or second laser beam guided to the photodetector 20 can set to 10:1. Therefore, S/N of the signal outputted from the photodetector 20 can be kept at a proper level.

Additionally, in the first embodiment, because the astigmatism is induced to the laser beam reflected from the optical disk when the laser beam is transmitted through the non-polarized mirror 13, it is not necessary to separately provide a lens element for inducing the astigmatism in order to detect the focus error. Therefore, the number of components can be decreased and the cost can be reduced.

### Second Embodiment

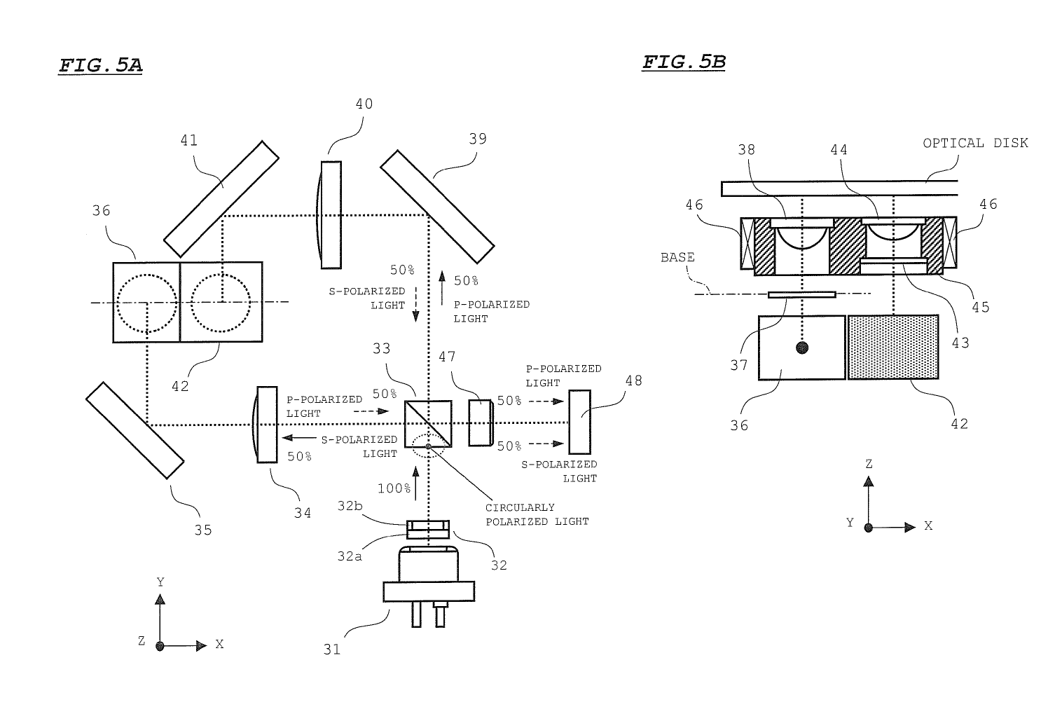

FIGS. 5A and 5B show a configuration (optical system) of an optical pickup device according to a second embodiment of the invention. FIG. 5A is a plan view showing an optical system from a semiconductor laser 31 to upwardly reflecting mirrors 36 and 42, and FIG. 5B is a side view showing an optical system from the upwardly reflecting mirrors 36 and 42. In FIG. 5B, a lens holder 45 is shown in section for the sake of convenience.

Referring to FIG. 5, the semiconductor laser (laser beam source) 31 emits the blue laser beam having the wavelength of about 405 nm, and a quarter-wave plate 32a and a diffraction grating 32b are integrally formed in an optical element 32. The quarter-wave plate 32a converts the laser beam from the semiconductor laser 31 into circularly polarized light. Accordingly, 50% (P-polarized light component) of the laser beam incident to the polarization beam splitter 33 is transmitted through the polarization beam splitter 33 and remaining 50% (S-polarized light component) of the laser beam is reflected by the polarization beam splitter 33.

A collimator lens 34 converts the laser beam (S-polarized light) reflected by the polarization beam splitter 33 into the parallel light. The upwardly reflecting mirror 36 reflects the laser beam, reflected by a reflecting mirror 35, toward a direction of a first objective lens 38.

A first quarter-wave plate 37 converts the laser beam reflected by the upwardly reflecting mirror 36 into the circularly polarized light. A first objective lens 38 causes the laser beam transmitted through the first quarter-wave plate 37 to converge on BD.

A reflecting mirror 39 reflects the laser beam (P-polarized light component) transmitted through the polarization beam splitter 33, and a collimator lens 40 converts the laser beam reflected by the reflecting mirror 39 into the parallel light. The upwardly reflecting mirror 42 reflects the laser beam reflected by the reflecting mirror 41 toward a direction of a second objective lens 44.

A second quarter-wave plate 43 converts the laser beam reflected by the upwardly reflecting mirror 42 into the circularly polarized light. The second objective lens 44 causes the laser beam transmitted through the second quarter-wave plate 43 to converge on HD.

A lens holder 45 holds the first objective lens 38, the second quarter-wave plate 43, and the second objective lens 44. A coil (part of the well-known objective lens actuator) 46 integrally drives the first objective lens 38, the second quarter-wave plate 43, and the second objective lens 44 along with the lens holder 45.

A detection lens 47 induces the astigmatism to the laser beam traveling from the polarization beam splitter 33 toward a photodetector 48, and the photodetector 48 accepts the laser beam reflected from HD or BD to generate various signals. In the second embodiment, the astigmatism generates the focus error signal. The quadratic sensor is provided in the photodetector 48 based on the astigmatism method as described later.

The first objective lens 38 and second objective lens 44 are designed so as to be able to cause the laser beam to converge properly on HD and BD. The first and second objective lenses 38 and 44 are integrally driven in the focus and tracking directions by an objective lens actuator (only the coil 46 is shown in FIG. 5).

In the second embodiment, the first objective lens 38 is made of glass, and a weight of the first objective lens 38 is larger than that of the second objective lens 44 made of plastic. In order to compensate the unbalance weight, only the second quarter-wave plate 43 in the first quarter-wave plate 37 and second quarter-wave plate 43 is attached to the lens holder 45, and the first quarter-wave plate 37 is disposed on the base side onto which the optical components of FIG. 5A are attached.

The quarter-wave plate 32a converts the laser beam emitted from the semiconductor laser 31 into the circularly polarized light, the diffraction grating 32b divides the laser beam into three beams, and the polarization beam splitter 33 reflects 50% of the light quantity component (hereinafter referred to as “first laser beam”) onto the side of the collimator lens 34. Then, the collimator lens 34 converts the first laser beam into the parallel light, the reflecting mirror 35 and the upwardly reflecting mirror 36 reflects the first laser beam, and the first quarter-wave plate 37 converts the first laser beam into the circularly polarized light. Then the first laser beam is incident to the first objective lens 18.

The first laser beam reflected by the optical disk (BD) travels reversely in the optical path in which the first laser beam travels toward the optical disk, and the first laser beam is incident to the polarization beam splitter 33. At this point, the first laser beam is transmitted through the first quarter-wave plate 37 again, whereby the first laser beam becomes the P-polarized light with respect to the polarization beam splitter 33. Therefore, the first laser beam is directly transmitted through the polarization beam splitter 33. Then, the detection lens 47 induces the astigmatism to the first laser beam, and the first laser beam converges on the photodetector 48.

On the other hand, in the laser beam incident to the polarization beam splitter 33 from the semiconductor laser 31 through the quarter-wave plate 32a and diffraction grating 32b, 50% of the light quantity component (hereinafter referred to as “second laser beam”) is transmitted through the polarization beam splitter 33 and incident to the reflecting mirror 39. The reflecting mirror 39 reflects the second laser beam, the collimator lens 40 converts the second laser beam into the parallel light, the reflecting mirror 41 and the upwardly reflecting mirror 42 reflect the second laser beam, and the second quarter-wave plate 43 converts the second laser beam into the circularly polarized light. Then, the second laser beam is incident to the second objective lens 44.

The second laser beam reflected by the optical disk (HD) travels reversely in the optical path in which the second laser beam travels toward the optical disk, and the second laser beam is incident to the polarization beam splitter 33. At this point, the second laser beam is transmitted through the second quarter-wave plate 43 again, whereby the second laser beam becomes the S-polarized light with respect to the polarization beam splitter 33. Therefore, the second laser beam is reflected by the polarization beam splitter 33. Then, the detection lens 37 induces the astigmatism to the second laser beam, and the second laser beam converges on the photodetector 48.

In the second embodiment, the light quantity ratio of the laser beam with which the optical disk is irradiated and the laser beam guided to the photodetector 48 becomes 1:1 (however, transmittance/reflectance of each optical component and the optical disk is not included). About 50% of the light quantity of the laser beam emitted from the semiconductor laser 31 is guided to the optical disk and the photodetector 48. Therefore, S/N of the signal outputted from the photodetector 48 is enough to be able to perform the reproduction.

In the second embodiment, the optical disk is simultaneously irradiated with the laser beams passing through the first and second objective lenses 38 and 44. However, similarly to the first embodiment, because the laser beam (flare light) which is not used for the reproduction is widely spread on the photodetector 48, the reproduction can smoothly be realized by a process of removing the DC component even if the laser beam (flare light) is incident to the photodetector 48. The signal computation circuit of the first embodiment shown in FIG. 4 can also be used in the second embodiment.

Thus, in the second embodiment, the inexpensive first and second quarter-wave plates 37 and 43 are used as the means for guiding the laser beam to the first and second objective lenses 38 and 44, so that the cost of the optical pickup device can be reduced. It is not necessary to provide the configuration for driving the liquid crystal cell and the configuration for inserting and retracting the half-wave plate, so that the complication of the configuration or control can be prevented.

Additionally, in the second embodiment, the whole of light quantities of the first and second laser beams reflected from the optical disk pass substantially through the polarization beam splitter 33, so that the light quantity of the laser beam guided to the photodetector 48 can be enhanced and the light quantity ratio of the laser beam with which the optical disk is irradiated and the first or second laser beam guided to the photodetector 48 can set to 1:1. Therefore, S/N of the signal outputted from the photodetector 48 can be enhanced higher than that of the first embodiment.

In the second embodiment, an inclination angle in a polarization direction of the laser beam is set to 45 degrees with respect to a polarizing axis of the polarization beam splitter 33, and the light quantity ratio of the first laser beam and the second laser beam is set to 1:1 after the polarization beam splitter 33 divides the laser beam into the first laser beam and the second laser beam. Alternately, the inclination angle in the polarization direction of the laser beam is appropriately adjusted with respect to the polarizing axis of the polarization beam splitter 33, which allows the light quantity ratio of the first laser beam and the second laser beam to be set to a predetermined value except for 1:1.

### Third Embodiment

In an optical pickup device according to a third embodiment of the invention, the optical pickup device of the first embodiment is changed. In the first embodiment (FIG. 1), the quarter-wave plate 15 converts the laser beam into the circularly polarized light to cause the laser beam to enter into the polarization beam splitter 16. On the other hand, the polarization direction of the laser beam is adjusted so as to be inclined with respect to the polarizing axis of the polarization beam splitter 16, whereby the same effect as the first embodiment is obtained. The optical pickup device of the third embodiment has a configuration in which the laser beam from the semiconductor laser 11 is sorted into the first and second objective lenses 17 and 19 by inclining the polarization direction of the laser beam with respect to the polarizing axis of the polarization beam splitter 16.

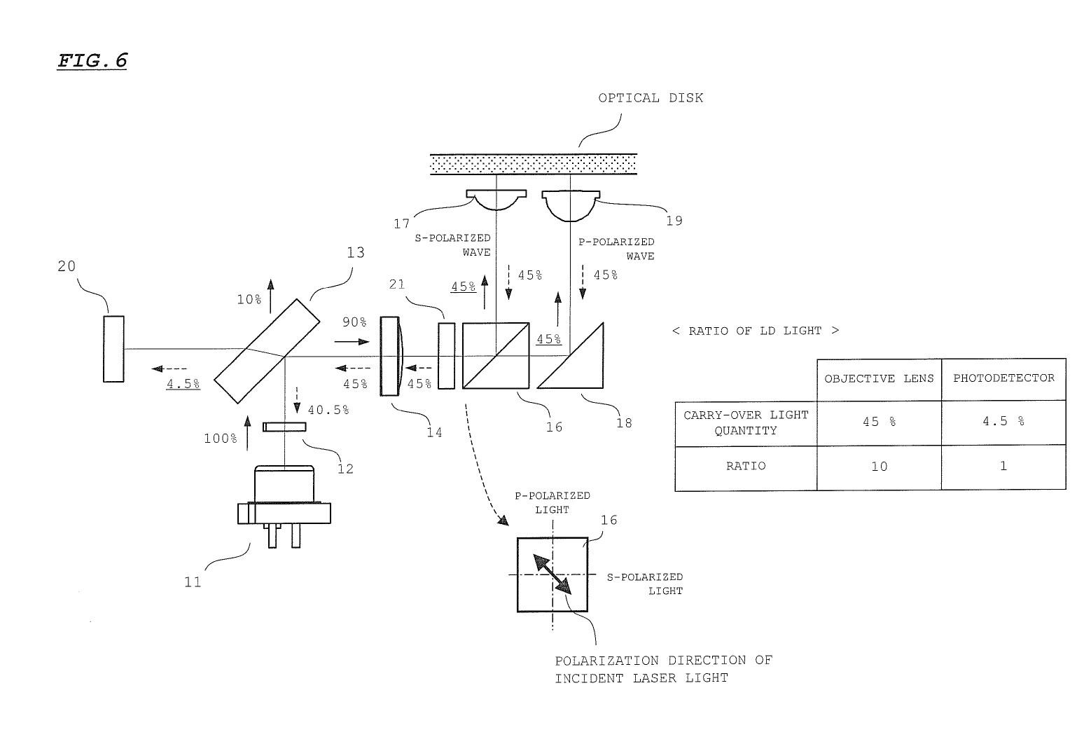

FIG. 6 shows a configuration of the optical pickup device of the third embodiment. In the third embodiment, the quarter-wave plate 15 of the first embodiment is replaced by the half-wave plate 21. Other configurations are similar to those of the first embodiment (FIG. 1).

As shown in FIG. 6, the half-wave plate 21 is disposed such that the polarization direction of the laser beam with respect to the polarization beam splitter 16 is inclined by 45 degrees in the direction of the P-polarized light and the direction of the S-polarized light. At this point, a half (S-polarized light) of the laser beam incident to the polarization beam splitter 16 is reflected by the polarization beam splitter 16 and the other half (P-polarized light) of the laser beam is transmitted through the polarization beam splitter 16. The light quantity ratio of the laser beams guided to the first and second objective lenses 17 and 19 can be changed from 1:1 by adjusting the polarization direction of the laser beam with respect to the polarization beam splitter 16.

The diffraction grating 12 divides the laser beam emitted from the semiconductor laser 11 into three beams, and the non-polarized mirror 13 divides the laser beam to reflect 90% of the laser beam onto the side of the collimator lens 14. Then, the collimator lens 14 converts the laser beam into the parallel light, and the half-wave plate 21 adjusts the polarization direction of the laser beam. Then, the laser beam is incident to the polarization beam splitter 16.

Thus, a half of the laser beam incident to the polarization beam splitter 16 is reflected as the form of the S-polarized light component by the polarization beam splitter 16, and the other half of the laser beam is transmitted as the P-polarized light component through the polarization beam splitter 16. The laser beam (first laser beam) of the S-polarized light component is collected on the optical disk through the first objective lens 17. The laser beam (second laser beam) of the P-polarized light component is reflected by the reflecting mirror 18, and the second laser beam is collected on the optical disk through the second objective lens 19. Accordingly, the light quantity of the laser beam with which the optical disk is irradiated through the first or second objective lenses 17 or 19 becomes 45% of the light quantity of the laser beam in the time when the laser beam is emitted from the semiconductor laser 11.

The polarization beam splitter 16 reflects about 100% of the first laser beam, because the first laser beam reflected by the optical disk is incident to the polarization beam splitter 16 in the form of the S-polarized light. The polarization beam splitter 16 transmits about 100% of the second laser beam reflected from the optical disk, because the second laser beam is incident to the polarization beam splitter 16 in the form of the P-polarized light.

Then, the collimator lens 14 converts the first and second laser beams into the convergent light and the non-polarized mirror 13 divides the first and second laser beams. As a result, the light quantity of the first and second laser beams guided to the photodetector 20 becomes 4.5% of the light quantity in the time when the laser beam is emitted from the semiconductor laser 11.

Because the first and second laser beams are incident to the non-polarized mirror 13 in the form of the convergent light, the non-polarized mirror 13 induces astigmatism to the first and second laser beams. In the third embodiment, similarly to the first embodiment, the astigmatism generates the focus error signal. Similarly to the first embodiment, a quadratic sensor is provided in the photodetector 20 based on an astigmatism method.

In the third embodiment, the light quantity ratio of the laser beam with which the optical disk is irradiated and the first or second laser beam guided to the photodetector 20 becomes 10:1 (however, transmittance/reflectance of each optical component and the optical disk is not included). Therefore, S/N of the signal outputted from the photodetector 20 is enough to be able to perform the reproduction.

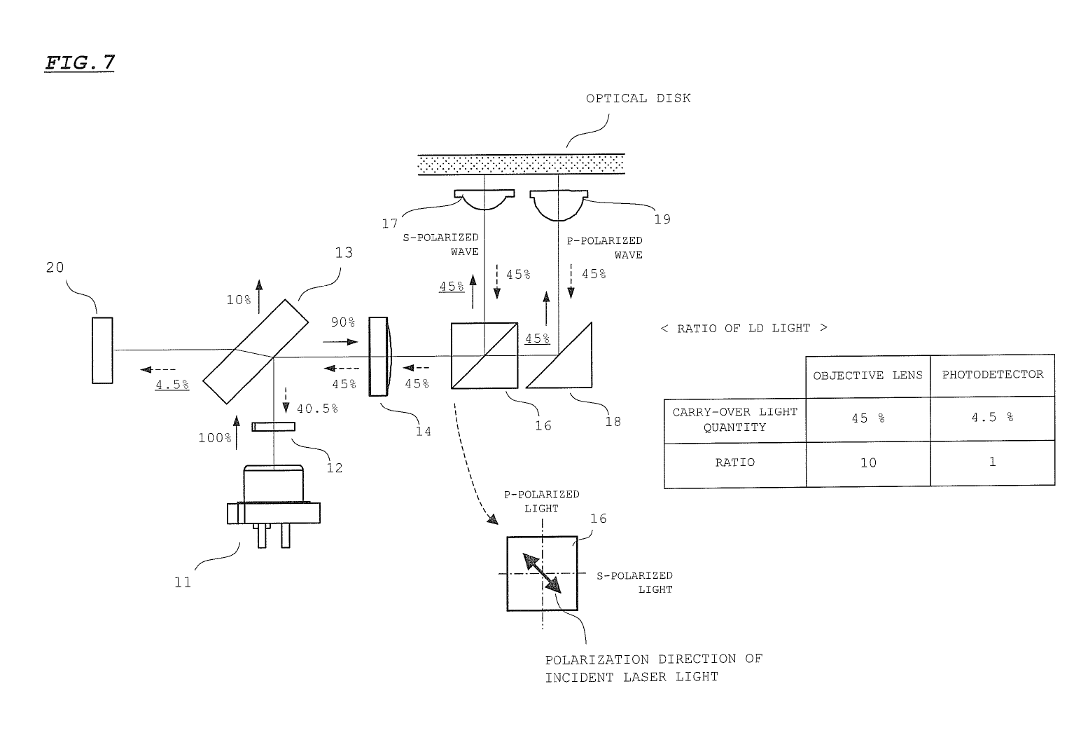

FIG. 7 shows a modification of the optical pickup device of the third embodiment. In the configuration of FIG. 7, the quarter-wave plate 15 is omitted and the arrangement of the semiconductor laser 11 is adjusted such that the polarization direction of the laser beam with respect to the polarization beam splitter 16 is inclined by 45 degrees in the direction of the P-polarized light and the direction of the S-polarized light in comparison with the configuration of FIG. 6. In the configuration of FIG. 7, a half (S-polarized light) of the laser beam incident to the polarization beam splitter 16 is reflected by the polarization beam splitter 16 and the other half (P-polarized light) of the laser beam is transmitted through the polarization beam splitter 16. A rotational position of the semiconductor laser 11 is adjusted about the optical axis to adjust the polarization direction of the laser beam with respect to the polarization beam splitter 16. Therefore, the light quantity ratio of the laser beams guided to first and second objective lenses 17 and 19 can be changed from 1:1.

In the configuration of FIG. 7, the quarter-wave plate 15 and the half-wave plate 21 are omitted in comparison with the first embodiment and the configuration of FIG. 6, so that the configuration can further be simplified.

### Fourth Embodiment

In an optical pickup device according to a fourth embodiment of the invention, the optical pickup device of the second embodiment is changed. In the second embodiment (FIGS. 5A and 5B), the quarter-wave plate 32a converts the laser beam into the circularly polarized light to cause the laser beam to enter into the polarization beam splitter 33. On the other hand, the polarization direction of the laser beam is adjusted so as to be inclined with respect to the polarizing axis of the polarization beam splitter 33, whereby the same effect as the second embodiment is obtained. The optical pickup device of the fourth embodiment has a configuration in which the laser beam from the semiconductor laser 31 is sorted into the first and second objective lenses 38 and 44 by inclining the polarization direction of the laser beam with respect to the polarizing axis of the polarization beam splitter 33.

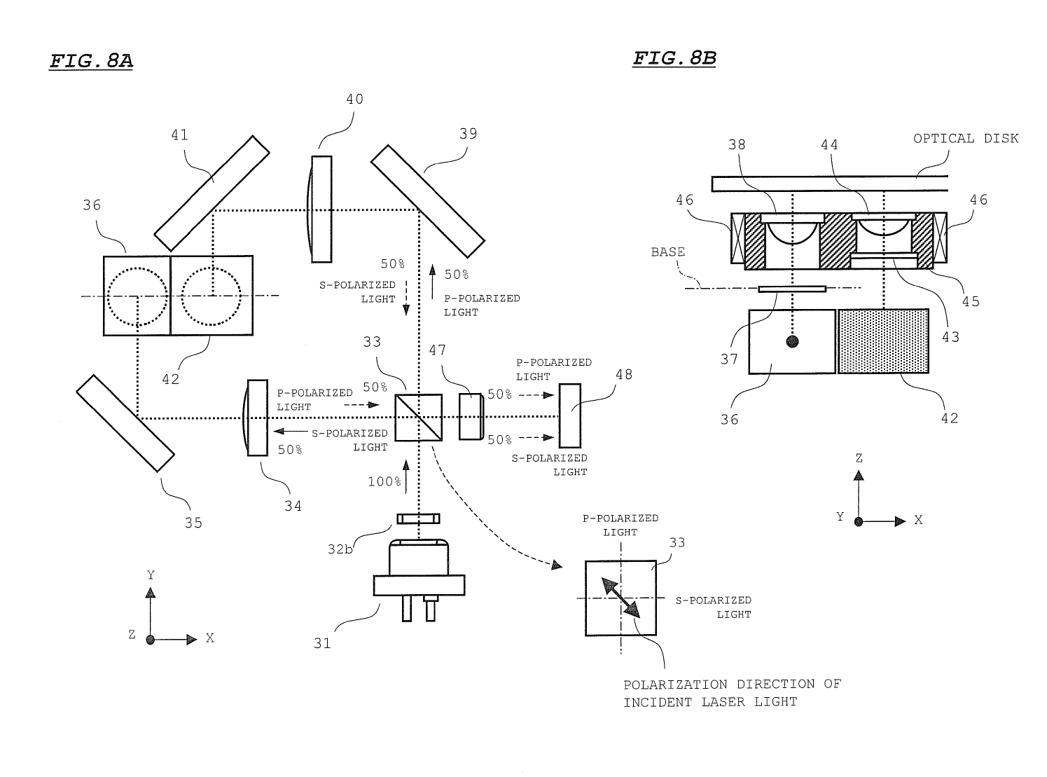

FIGS. 8A and 8B show a configuration of an optical pickup device according to a fourth embodiment of the invention. FIG. 8A is a plan view showing an optical system from the semiconductor laser 31 to the upwardly reflecting mirrors 36 and 42, and FIG. 8B is a side view showing an optical system from the upwardly reflecting mirrors 36 and 42. In FIG. 8B, the lens holder 45 is shown in section for the sake of convenience.

In the fourth embodiment, the quarter-wave plate 32a of the second embodiment is omitted. In the semiconductor laser 31, the rotational position of the optical axis of the laser beam is adjusted such that the polarization direction of the laser beam is inclined by 45 degrees with respect to the polarizing axis when the laser beam is incident to the polarization beam splitter 33. Accordingly, 50% (P-polarized light) of the laser beam incident to the polarization beam splitter 33 is transmitted through the polarization beam splitter 33 and remaining 50% (S-polarized light) is reflected by the polarization beam splitter 33. Other configurations are similar to those of the second embodiment (FIGS. 5A and 5B).

The diffraction grating 32b divides the laser beam emitted from the semiconductor laser 31 into three beams, and the polarization beam splitter 33 reflects 50% of the light quantity component (first laser beam) onto the side of the collimator lens 34. Then, the collimator lens 34 converts the first laser beam into the parallel light, the reflecting mirror 35 and the upwardly reflecting mirrors 36 reflect the first laser beam, and the first quarter-wave plate 37 converts the first laser beam into the circularly polarized light. Then, the first laser beam is incident to the first objective lens 38.

The first laser beam reflected by the optical disk (BD) travels reversely in the optical path in which the first laser beam travels toward the optical disk, and the first laser beam is incident to the polarization beam splitter 33. At this point, the first laser beam is transmitted through the first quarter-wave plate 37 again, whereby the first laser beam becomes the P-polarized light with respect to the polarization beam splitter 33. Therefore, the first laser beam is directly transmitted through the polarization beam splitter 33. Then, the detection lens 47 induces the astigmatism to the first laser beam, and the first laser beam converges on the photodetector 48.

On the other hand, in the laser beam incident to the polarization beam splitter 33 from the semiconductor laser 31 through the diffraction grating 32b, 50% of the light quantity component (second laser beam) is transmitted through the polarization beam splitter 33 and incident to the reflecting mirror 39. The reflecting mirror 39 reflects the second laser beam, the collimator lens 40 converts the second laser beam into the parallel light, the reflecting mirror 41 and the upwardly reflecting mirror 42 reflect the second laser beam, and the second quarter-wave plate 43 converts the second laser beam into the circularly polarized light. Then, the second laser beam is incident to the second objective lens 44.

The second laser beam reflected by the optical disk (HD) travels reversely in the optical path in which the second laser beam travels toward the optical disk, and the second laser beam is incident to the polarization beam splitter 33. At this point, the second laser beam is transmitted through the second quarter-wave plate 43 again, whereby the second laser beam becomes the S-polarized light with respect to the polarization beam splitter 33. Therefore, the second laser beam is reflected by the polarization beam splitter 33. Then, the detection lens 47 induces the astigmatism to the second laser beam, and the second laser beam converges on the photodetector 48.

In the fourth embodiment, the light quantity ratio of the laser beam with which the optical disk is irradiated and the laser beam guided to the photodetector 48 becomes 1:1 (however, transmittance/reflectance of each optical component and the optical disk is not included). About 50% of the light quantity of the laser beam emitted from the semiconductor laser 31 is guided to the optical disk and the photodetector 48. Therefore, S/N of the signal outputted from the photodetector 48 is enough to be able to perform the reproduction.

The light quantity ratio of the laser beams guided to the first and second objective lenses 38 and 44 can be changed from 1:1 by adjusting the polarization direction of the laser beam with respect to the polarization beam splitter 33.

In the configurations of the FIGS. 8A and 8B, the rotational position of the semiconductor laser 31 is adjusted about the optical axis of the laser beam such that the inclination angle of the polarization direction of the laser beam becomes 45 degrees with respect to the polarizing axis of the polarization beam splitter 33. Alternatively, the half-wave plate may be disposed between the semiconductor laser 31 and the polarization beam splitter 33 to adjust the inclination angle of the polarization direction of the laser beam with respect to the polarizing axis of the polarization beam splitter 33.

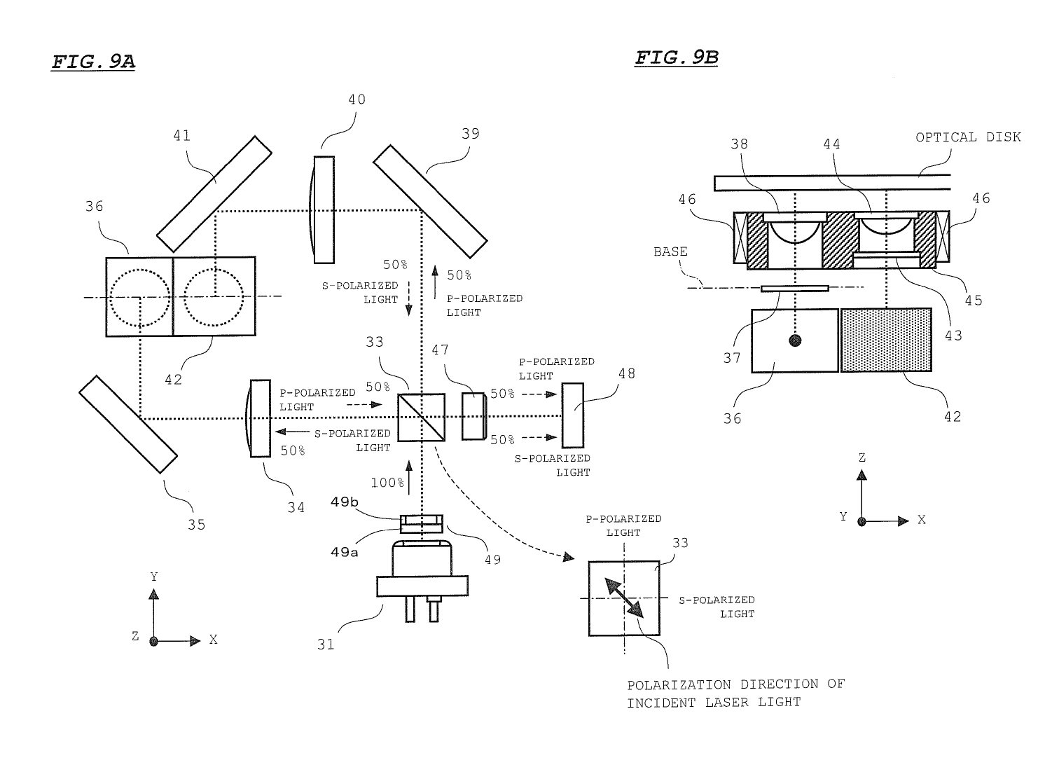

FIGS. 9A and 9B show a modification of the optical pickup device of the fourth embodiment. In the configuration of FIG. 9, an optical element 49 in which a half-wave plate 49a and a diffraction grating 49b are integrally formed is disposed between the semiconductor laser 31 and the polarization beam splitter 33. At this point, in the optical element 49 the diffraction action of the diffraction grating 49b properly positions three beams on the tracks of BD or HD, when the half-wave plate 49a is located such that the inclination angle of the polarization direction of the laser beam becomes 45 degrees with respect to the polarizing axis of the polarization beam splitter 33. Therefore, in assembling the optical system, it is not necessary to separately adjust the arrangement of the diffraction grating 49b, and improvement of workability can be achieved.

Thus, the embodiments of the invention are described. However, the invention is not limited to the embodiments, but various changes and modifications of the embodiments can be made.

For example, the light dividing ratio of the non-polarized mirror 13 is set to 9:1 in the first and third embodiments. However, other light dividing ratios may be adopted.

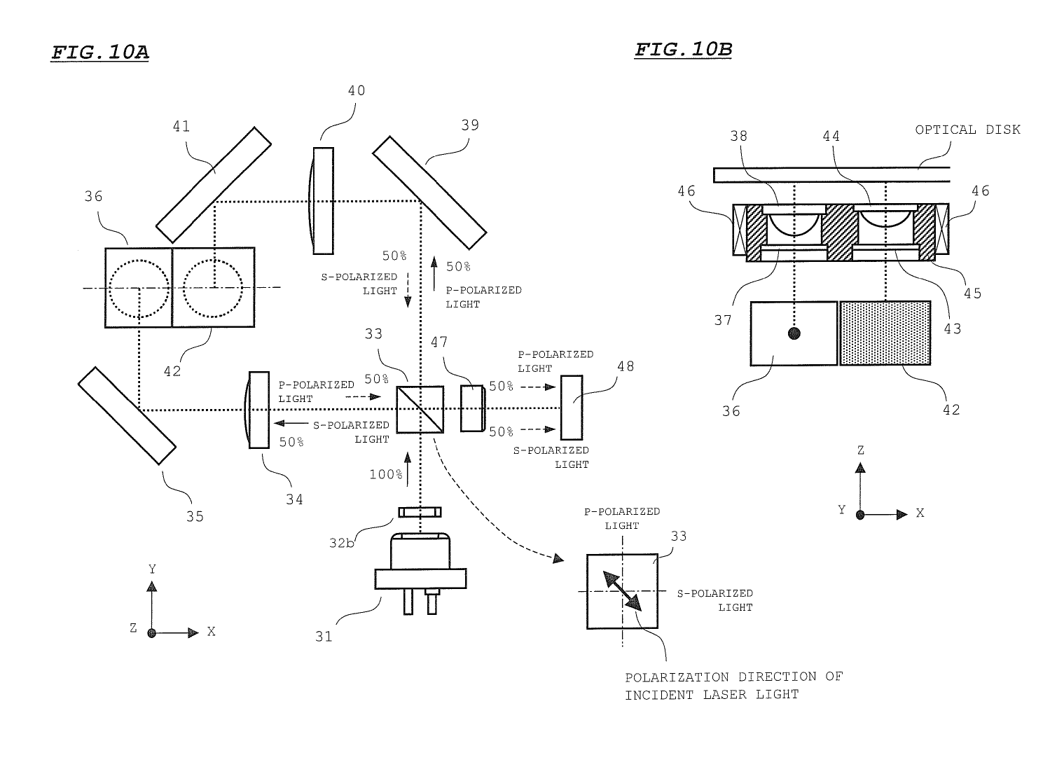

In the second and fourth embodiments, in order to compensate the unbalance weight between the first objective lens 38 and the second objective lens 44, the second quarter-wave plate 43 is disposed in the lens holder 45 and the first quarter-wave plate 37 is disposed on the base side. For example, in the case where the weight of the first objective lens 38 is reduced to decrease the difference in weight between the two objective lenses to an extent that the difference in weight has no influence on a driving property of the objective lens, as shown in FIGS. 10A and 10B, the first quarter-wave plate 37 is also disposed on the side of the lens holder 45, and the first quarter-wave plate 37, the first objective lens 38, the second quarter-wave plate 43, and the second objective lens 44 may integrally be driven along with the lens holder 45.

In the case where both the first quarter-wave plate 37 and the second quarter-wave plate 43 are provided in the lens holder 45, the first quarter-wave plate 37 and the second quarter-wave plate 43 may integrally be formed, namely, the common quarter-wave plate may be provided in the optical paths of the first and second laser beams.

Various changes and modifications of the embodiment can be made without departing from the scope of the technical thought shown in claims of the invention.

What is claimed is:

1. An optical pickup device comprising:
a laser beam source which emits a laser beam having a predetermined wavelength;
first and second objective lenses which cause the laser beam to converge;
a polarization beam splitter which sorts the laser beam from the laser beam source into the first and second objective lenses; and
a quarter-wave plate which is disposed between the laser beam source and the polarization beam splitter, the quarter-wave plate causing the laser beam to enter into the polarization beam splitter in a form of circularly polarized light.

2. The optical pickup device according to claim 1, comprising a plate-like non-polarized mirror which is disposed in a diffusion optical path of the laser beam between the laser beam source and the quarter-wave plate while inclined with respect to an optical axis of the laser beam,
wherein part of the laser beam emitted from the laser beam source is reflected toward a direction of the quarter-wave plate by the non-polarized mirror, and
part of the laser beam from the quarter-wave plate toward the non-polarized mirror is incident to a photodetector through the non-polarized mirror.

3. An optical pickup device comprising:
a laser beam source which emits a laser beam having a predetermined wavelength;
first and second objective lenses which cause the laser beam to converge on a recording medium;
a polarization beam splitter which sorts the laser beam from the laser beam source into the first and second objective lenses;
first and second quarter-wave plates which are disposed in optical paths between the polarization beam splitter and the first and second objective lenses respectively;
a photodetector which accepts the laser beam, the laser beam being reflected by the recording medium and passing the polarization beam splitter; and
a quarter-wave plate which is disposed between the laser beam source and the polarization beam splitter, the quarter-wave plate causing the laser beam to enter into the polarization beam splitter in a form of circularly polarized light.

4. An optical pickup device comprising:
a laser beam source which emits a laser beam having a predetermined wavelength;
first and second objective lenses which cause the laser beam to converge;
a polarization beam splitter which sorts the laser beam from the laser beam source into the first and second objective lenses; and
a half-wave plate which is disposed between the laser beam source and the polarization beam splitter, the half-wave plate causing the laser beam to enter into the polarization beam splitter in a form of linearly polarized light inclined by a predetermined angle with respect to a polarizing axis of the polarization beam splitter.

5. The optical pickup device according to claim 4, comprising a plate-like non-polarized mirror which is disposed in a diffusion optical path of the laser beam between the laser beam source and the half-wave plate while inclined with respect to an optical axis of the laser beam,
wherein part of the laser beam emitted from the laser beam source is reflected toward a direction of the half-wave plate by the non-polarized mirror, and
part of the laser beam from the half-wave plate toward the non-polarized mirror is incident to the photodetector through the non-polarized mirror.

6. An optical pickup device comprising:
a laser beam source which emits a laser beam having a predetermined wavelength;
first and second objective lenses which cause the laser beam to converge; and
a polarization beam splitter which sorts the laser beam from the laser beam source into the first and second objective lenses,
wherein the laser beam source is disposed such that the laser beam emitted from the laser beam source is incident in a form of linearly polarized light inclined by a predetermined angle with respect to a polarizing axis of the polarization beam splitter.

7. The optical pickup device according to claim 6, comprising a plate-like non-polarized mirror which is disposed in a diffusion optical path of the laser beam between the laser beam source and the polarization beam splitter while inclined with respect to an optical axis of the laser beam,
wherein part of the laser beam emitted from the laser beam source is reflected toward a direction of the polarization beam splitter by the non-polarized mirror, and
part of the laser beam from the polarization beam splitter toward the non-polarized mirror is incident to the photodetector through the non-polarized mirror.

8. An optical pickup device comprising:
a laser beam source which emits a laser beam having a predetermined wavelength;
first and second objective lenses which cause the laser beam to converge onto a recording medium;
a polarization beam splitter which sorts the laser beam from the laser beam source into the first and second objective lenses;
first and second quarter-wave plates which are disposed in optical paths between the polarization beam splitter and the first and second objective lenses respectively; and
a photodetector which accepts the laser beam, the laser beam being reflected by the recording medium and passing the polarization beam splitter,
wherein the laser beam emitted from the laser beam source is incident in a form of linearly polarized light inclined by a predetermined angle with respect to a polarizing axis of the polarization beam splitter.

9. The optical pickup device according to claim 8, wherein a rotational position of the laser beam source is adjusted about a laser beam axis such that the laser beam emitted from the laser beam source is incident in a form of linearly polarized light inclined by a predetermined angle with respect to a polarizing axis of the polarization beam splitter.

10. The optical pickup device according to claim 8, wherein a half-wave plate is disposed in an optical path between the laser beam source and the polarization beam splitter, the half-wave plate causing the laser beam to enter into the polarization beam splitter in a form of linearly polarized light inclined by the predetermined angle with respect to a polarizing axis of the polarization beam splitter.

11. The optical pickup device according to claim 10, wherein a diffraction grating and the half-wave plate are integrally formed to split the laser beam emitted from the laser beam source into three beams.
